(19) United States
(12) Patent Application Publication
(10) Pub. No.: US 2005/0280369 A1
(43) Pub. Date: Dec. 22, 2005

(54) Plasma display panel

(75) Inventor: Hirokazu Hashikawa, Yamanashi-ken (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Pioneer Corporation, Tokyo (JP)

(21) Appl. No.: 11/152,380

(22) Filed: Jun. 15, 2005

(30) Foreign Application Priority Data
Jun. 22, 2004 (JP) 2004-183508

(51) Int. Cl. H01J 11/02; H01J 17/49

(52) U.S. Cl. 313/586

(57) ABSTRACT

Row electrode pairs and column electrodes are placed between a front glass substrate and a back glass substrate facing each other on either side of a discharge space of a PDP. The row electrode pairs and the column electrodes extend in directions at right angles to each other to form unit light-emitting areas at intersections with each other in the discharge space. A low-dielectric layer is formed on the back glass substrate, and formed of a low-dielectric material having a dielectric constant smaller than that of the back glass substrate. The column electrodes are formed on the low-dielectric layer.

### BACKGROUND OF THE INVENTION

1. Field of the Invention

This invention relates to the panel structure of surface-discharge-type alternating-current plasma display panels.

The present application claims priority from Japanese Application No. 2004-183508, the disclosure of which is incorporated herein by reference.

2. Description of the Related Art

FIG. 1 is a sectional view illustrating the conventional structure of a plasma display panel (hereinafter referred to as “PDP”) taken in the column direction (the vertical direction of the panel).

In FIG. 1, the conventional PDP has the front glass substrate 1 serving as the display surface. The front glass substrate 1 having the back-facing face (facing toward the back of the panel) on which a plurality of row electrode pairs (X, Y) each extending in the row direction of the front glass substrate (the vertical direction at right angles to the drawing in FIG. 1) are arranged parallel to each other.

Each of the row electrodes X and Y in each row electrode pair (X, Y) is composed of a bus electrode Xa (Ya) formed of a metal film and extending in the row direction of the front glass substrate 1, and transparent electrodes Xb (Yb) connected to the bus electrode Xa (Ya) and spaced at regular intervals, and extending out from the bus electrode Xa (Ya) toward its counterpart row electrode Ya (Xa), in which a transparent electrode Xb and the corresponding transparent electrode Yb face each other with a display gap g in between.

On the back-facing face of the front glass substrate 1, a dielectric layer 2 is further formed and covers the row electrode pairs (X, Y) and a protective layer 3 is formed on the back-facing face of the dielectric layer 2.

The front glass substrate 1 is placed parallel to a back glass substrate 4 with a discharge space in between. The back glass substrate 4 has a front-facing face (facing toward the display surface) on which column electrodes D each extend, in a direction at right angles to the row electrode pairs (X, Y) (in the column direction), along a strip opposite the opposed transparent electrodes Xb and Yb of the row electrode pairs (X, Y) and are spaced parallel to and at predetermined intervals from each other.

A white column-electrode protective layer 5 is formed on the front-facing face of the back glass substrate 4 and covers the column electrodes D. In turn, a partition wall unit 6 is formed on the column-electrode protective layer 5 and defines quadrangular discharge cells C which are formed in the discharge space in correspondence with the respective intersections between the row electrode pairs (X, Y) and the column electrodes.

In each discharge cell C, a phosphor layer 7 is formed so as to cover the five faces: the side faces of the partition wall unit 6 and the face of the column-electrode protective layer 5. The primary three colors, red, green and blue, are applied to the phosphor layers 7, so that the red, green and blue phosphor layers 7 are arranged in order in the row direction.

The discharge space between the front glass substrate 1 and the back glass substrate 4 is filled with a discharge gas including xenon.

A conventional PDP of such a structure is disclosed in Japanese unexamined patent publication 2000-311612, for example.

The PDP initiates a reset discharge, an address discharge and a sustaining discharge in the discharge cells C for the generation of images.

More specifically, in a reset period, a reset discharge is produced simultaneously between paired transparent electrodes Xb and Yb in the row electrode pairs (X, Y), resulting in an complete erasure of wall charge deposited on a portion of the dielectric layer 2 facing each discharge cell C (or in deposition of wall charge on the portion of the dielectric layer 2 in each discharge cell C). In the following address period, an address discharge is produced selectively between the transparent electrodes Yb of the row electrode Y and the column electrodes D. The address discharge results in the distribution of the light-emitting cells having the deposition of the wall charge on the dielectric layer 2 and the no-light-emitting cells in which the wall charge has been erased from the dielectric layer 2 over the panel surface in accordance with an image to be generated.

In the following sustaining discharge period, a sustaining discharge is produced between the paired transparent electrodes Xb and Yb of the row electrode pair (X, Y) in each of the light-emitting cells. The sustaining discharge results in the emission of vacuum ultraviolet light from the xenon in the discharge gas. The vacuum ultraviolet light excites the phosphor layers 7, whereupon the red-, green- and blue-colored phosphor layers 7 emit visible light to generate an image on the panel surface.

The conventional PDPs structured as described above typically use the back glass substrate 4 of a dielectric constant of about eight.

For this reason, when voltage for the address discharge is applied to a selected column electrode D formed on the back glass substrate 4, a high electrostatic capacity arises between the column electrode D to which the voltage is applied and another column electrode D and/or the row electrode pair (X, Y) which are located close to this column electrode D, and causes an increase in reactive power. This is a problem which arises in the conventional PDPs.

### SUMMARY OF THE INVENTION

It is an object of the present invention to solve the problems associated with conventional PDPs as described earlier.

To attain this object, a first aspect of the present invention provides a plasma display panel that includes row electrode pairs and column electrodes that are placed between a pair of first and second substrates facing each other on either side of a discharge space and extend in directions at right angles to each other to form unit light-emitting areas at intersections with each other in the discharge space. The plasma display panel is characterized by a low-dielectric layer that is formed of a low-dielectric material having a dielectric constant smaller than that of the first substrate and provided on the first substrate, and by providing the column electrodes on the low-dielectric layer.

To attain the above-mentioned object, a second aspect of the present invention provide a plasma display panel including row electrode pairs and column electrodes that are provided between a pair of first and second substrates facing each other on either side of a discharge space and extend in directions at right angles to each other to form unit light-emitting areas at intersections with each other in the discharge space. The plasma display panel is characterized in that the first substrate is formed of a low-dielectric material having a dielectric constant smaller than that of the second substrate, and the column electrodes are formed on the first substrate.

In the best mode for carrying out the present invention, a PDP has row electrode pairs formed on the back-facing face of a front glass substrate, and column electrodes extending in a direction at right angles to the row electrode pair. The column electrodes are formed on a low-dielectric layer formed of a material having a low dielectric constant. For example, the low-dielectric layer is formed on a back glass substrate placed parallel to the front glass substrate with a discharge space in between, and formed of a low-dielectric material with a dielectric constant smaller than that of the back glass substrate. Alternatively, the low-dielectric layer is formed of a low-dielectric material with a dielectric constant smaller than that of the front glass substrate and constitutes a back substrate.

In the PDP in this best mode, because the column electrodes are provided on the low-dielectric layer, when voltage is applied to any column electrode in an address period for generating an image, the electrostatic capacity arising between the column electrode to which the voltage is applied and another column electrode or the row electrode is smaller than that in a conventional PDP, resulting in a reduction in reactive power produced when an image is generated to reduce the electrical power consumption of the PDP.

The reduction in reactive power enables the use of a driver having a small current carrying capacity as a driver for driving the PDP. This makes a reduction in manufacturing costs for the PDP possible.

These and other objects and features of the present invention will become more apparent from the following detailed description with reference to the accompanying drawings.

### BRIEF DESCRIPTION OF THE DRAWINGS

FIG. 1 is a sectional view illustrating the structure of a conventional PDP.

FIG. 2 is a schematic front view of a first embodiment of the present invention.

FIG. 3 is a sectional view taken along the line V-V in FIG. 2.

FIG. 4 is a sectional view taken along the line W-W in FIG. 2.

FIG. 5 is a graph showing the relationship between the thickness of a low-dielectric layer and address-related electrostatic capacity in the first embodiment.

FIG. 6 is a graph showing the comparison of address-related electrostatic capacity and sustaining-related electrostatic capacity in the first embodiment.

FIG. 7 is a graph showing the comparison of address-related electrostatic capacities in the first embodiment.

FIG. 8 is a graph showing the comparison of sustaining-related electrostatic capacities in the first embodiment.

FIG. 9 is a schematic sectional view of a second embodiment according to the present invention.

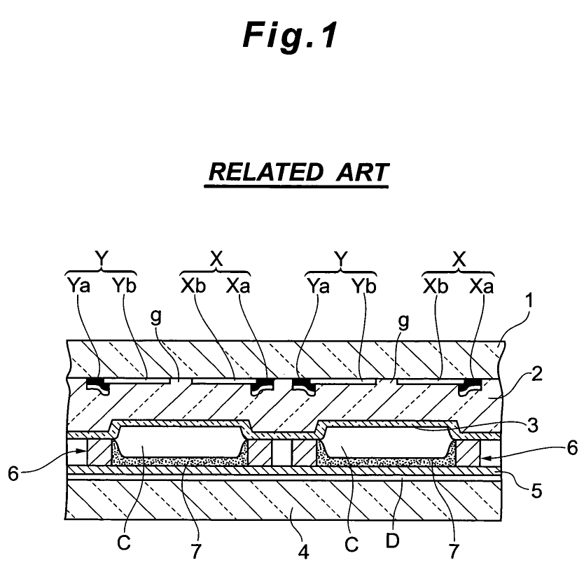

### DETAILED DESCRIPTION OF THE PREFERRED EMBODIMENTS

### First Embodiment

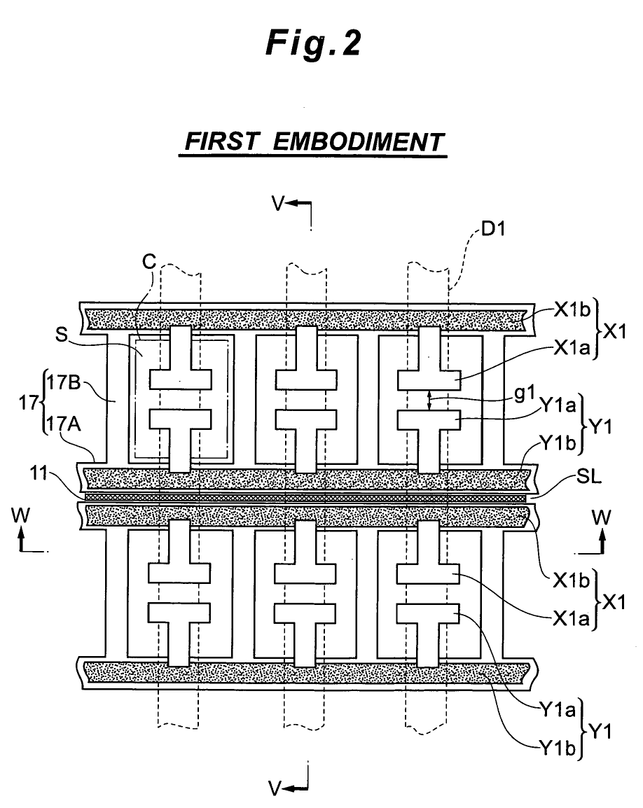

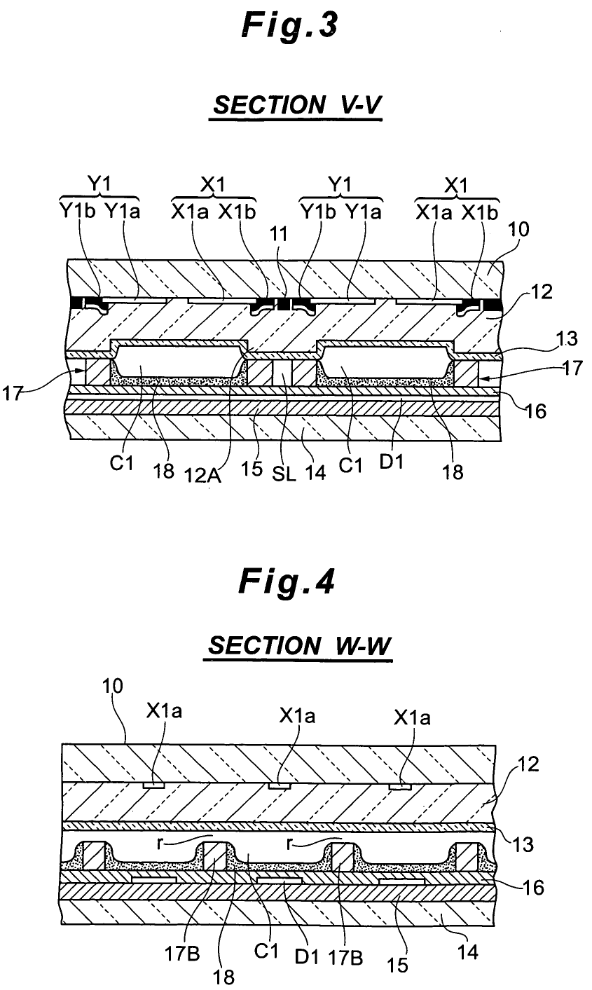

FIGS. 2 to 4 illustrate a first embodiment of a PDP according to the present invention. FIG. 2 is a schematic front view of the PDP in the first embodiment. FIGS. 3 and 4 are sectional views respectively taken along the V-V line and the W-W line in FIG. 2.

In the PDP in FIGS. 2 to 4, a plurality of row electrode pairs (X1, Y1) is formed on the back-facing face of a front glass substrate 10 serving as the display surface. The row electrode pairs (X1, Y1) each extend in the row direction of the front glass substrate 10 (in the right-left direction in FIG. 2), and are arranged parallel to each other.

A row electrode X1 in each row electrode pair (X1, Y1) is composed of T-shaped transparent electrodes X1a each formed of a transparent conductive film made of ITO or the like, and a metallic bus electrode X1b extending in the row direction of the front glass substrate 10 and connected to the proximal end (corresponding to the foot of “T”) of each of the transparent electrodes X1a.

Likewise, a row electrode Y1 is composed of T-shaped transparent electrodes Y1a each formed of a transparent conductive film made of ITO or the like, and a metallic bus electrode Y1b extending in the row direction of the front glass substrate 10 and connected to the proximal end (corresponding to the foot of “T”) of each of the transparent electrodes Y1a.

The row electrodes Y1 and the row electrodes X1 are arranged in alternate positions in the column direction of the front glass substrate 10 (the vertical direction in FIG. 2). Each of the transparent electrodes X1a which are regularly spaced along the bus electrode X1b and each of the transparent electrodes Y1a regularly spaced along the bus electrode Y1b in each row electrode pair extend out from the associated bus electrodes toward their counterpart row electrode, so that the distal ends (corresponding to the head of “T”) of the transparent electrodes X1a and Y1a face each other on either side of a discharge gap g1 having a required width.

Black- or dark-colored light absorption layers (light-shield layers) 11 are formed on the back-facing face of the front glass substrate 10. Each of the light absorption layers 11 extends in the row direction parallel to and between the back-to-back bus electrodes X1b and Y1b of the row electrode pairs (X1, Y1) adjacent to each other in the column direction.

A dielectric layer 12 is further formed on the back-facing face of the front glass substrate 10 and covers the row electrode pairs (X1, Y1). Additional dielectric layers 12A protrude from the back-facing face of the dielectric layer 12 toward the back of the PDP. Each of the additional dielectric layers 12A extends parallel to the back-to-back bus electrodes X1b and Y1b of the adjacent row electrode pairs (X1, Y1) along a strip opposite these bus electrodes X1b and Y1b and the light absorption layer 11 located between these bus electrodes X1b and Y1b.

An MgO protective layer 13 is formed on the dielectric layer 12 and the additional dielectric layers 12A.

The front glass substrate 10 is placed parallel to a back glass substrate 14 with a discharge space S in between. On the front-facing face of the back glass substrate 14, a white low-dielectric layer 15 is formed of a low-dielectric-constant material including SiO₂ and having a lower dielectric constant than that of a glass material essentially constituting the back glass substrate 14.

The low-dielectric layer 15 is formed all over the back glass substrate 14 by a thick-film forming method, such as printing or direct coating, to a thickness of about 100 μm.

Column electrodes D1 are formed on the low-dielectric layer 15. The column electrodes D1 each extend in a direction at right angles to the row electrode pair (X1, Y1) (in the column direction) along a strip opposite paired transparent electrodes of the row electrode pairs (X1, Y1), and are arranged parallel to and at predetermined intervals from each other.

A white column-electrode protective layer 16 is further formed on the front-facing face of the low-dielectric layer 15 and covers the column electrodes D1. In turn, partition wall units 17 are formed on the column-electrode protective layer 16.

Each of the partition wall units 17 is formed in an approximate ladder shape made up of a pair of lateral walls 17A extending in the row direction along a strip opposite the bus electrodes X1b and Y1b of each row electrode pair (X1, Y1), and vertical walls 17B each extending in the column direction between the pair of lateral walls 17A in a mid-position between the adjacent column electrodes D1. The partition wall units 17 are arranged parallel to each other in the column direction such that an interstice SL extends in the row direction between the back-to-back lateral walls 17A of two adjacent partition wall units 17.

The ladder-shaped partition wall units 17 partition the discharge space S defined between the front glass substrate 10 and the back glass substrate 14 into quadrangular discharge cells C1 each corresponding to the opposing portions of the paired transparent electrodes X1a and Y1a in each row electrode pair (X1, Y1).

A phosphor layer 18 is formed in each discharge cell C1 so as to cover all the five faces facing the discharge cell C1: the side faces of the lateral walls 17A and the vertical walls 17B of the partition wall unit 17 and the front-facing face of the column-electrode protective layer 16. The primary three colors, red, green and blue, are applied individually to the phosphor layers 18, so that the red, green and blue discharge cells C1 are arranged in order in the row direction.

A portion of the protective layer 13 covering each of the additional dielectric layers 12A is in contact with the front-facing face of the lateral wall 17A of the partition wall unit 17 (see FIG. 3). Hence, the interstice SL is blocked from the discharge cells C1. However, the front-facing face of each vertical wall 17B is out of contact with the protective layer 13 (see FIG. 4) to form a clearance r. Hence, adjacent discharge cells C1 in the row direction communicate by means of the clearance r.

The discharge space S is filled with a discharge gas including xenon (Xe).

As in the case of a conventional PDP, the foregoing PDP in the first embodiment produces a reset discharge simultaneously between paired transparent electrodes X1a and Y1a in each row electrode pair (X1, Y1) in a reset period. Thus, the wall charge is completely erased from (or deposited on) the portion of the dielectric layer 12 facing each of the discharge cells C1.

In the following address period, an address discharge is initiated selectively between the transparent electrodes Y1a of the row electrodes Y1 to which a scan pulse is applied and the column electrodes D1 to which a data pulse is applied. Thus, the light-emitting cells in which the wall charge deposits on the dielectric layer and the no-light-emitting cells in which the wall charge has been erased from the dielectric layer 2 are distributed over the panel surface in accordance with image data in a video signal.

In the following sustaining discharge period, a sustaining discharge is produced between the paired transparent electrodes X1a and Y1a of the row electrode pair (X1, Y1) in each of the light-emitting cells. The sustaining discharge results in the emission of vacuum ultraviolet light from the xenon in the discharge gas. The vacuum ultraviolet light excites the phosphor layers 18, whereupon the red-, green- and blue-colored phosphor layers 18 emit visible light to generate an image on the panel surface.

With this structure of the PDP, the column electrodes D1 are formed on the white low-dielectric layer 15 which is formed of a low-dielectric-constant material having a lower dielectric constant than that of the back glass substrate 14. For this reason, when a data pulse (voltage) is applied to any column electrode D1 in the address period for the generation of the image, the electrostatic capacity arising between the column electrode D1 to which this voltage has been applied and another column electrode D1, the row electrodes X1 and/or Y1 which are located close to this column electrode D1 is smaller than that in the conventional PDP having column electrodes formed directly on the back glass substrate. Thereby, the reactive power arising when the image is generated is decreased, leading to a reduction in the electrical power consumption of the PDP.

The decrease in reactive power enables the use of a driver having a small current carrying capacity as the address driver driving the PDP (a driver which controls voltage applied to the column electrodes D1). This makes a reduction in manufacturing costs for the PDP possible.

Transparency is not required of the low-dielectric layer 15 of the PDP because it is formed on the back glass substrate 14. Therefore, the low-dielectric layer 15 is formed of a white material including SiO₂ so as to reflect the light emitted from the phosphor layer 18 for an improvement in the luminous efficiency of the PDP.

In order to further improve the luminous efficiency, the low-dielectric layer 15 may include a bright-colored pigment.

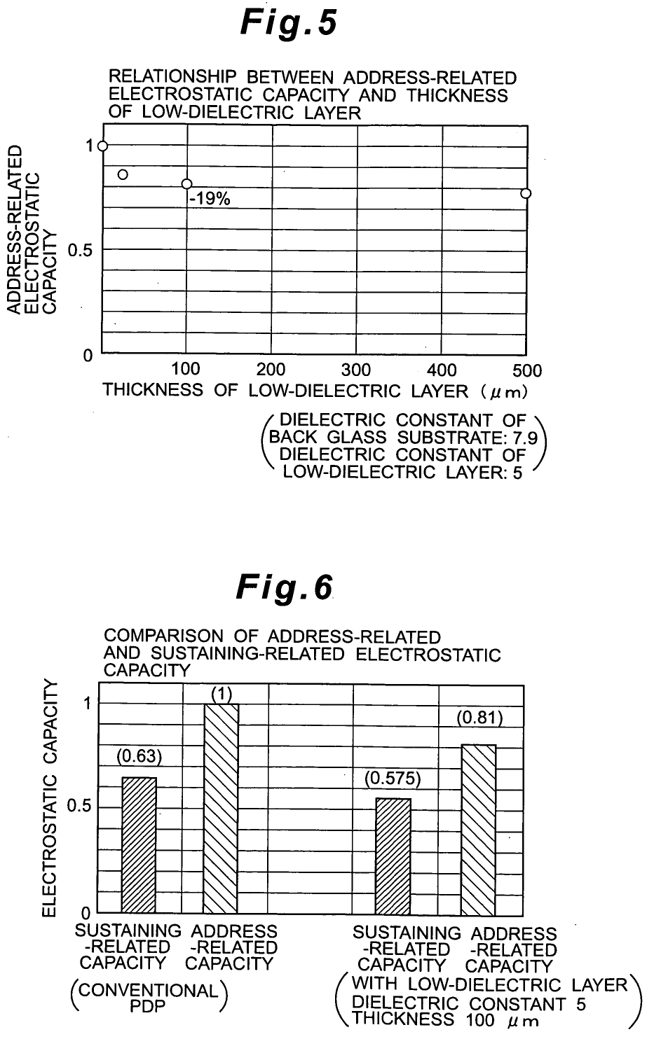

FIG. 5 is a chart showing the relationship between the thickness of the low-dielectric layer 15 of the PDP and the electrostatic capacity arising between a column electrode D1 to which voltage is applied and another column electrode D1, row electrode pair X1 and/or Y1 which are located close to this column electrode D1 (the address-related electrostatic capacity).

The horizontal axis in FIG. 5 shows the thickness of the low-dielectric layer 15 formed of a low-dielectric material of a dielectric constant of five.

A thickness of 0 μm of the low-dielectric layer 15 on the horizontal axis means the case where the column electrodes D1 are formed directly on the back glass substrate 14 as in the conventional PDP.

The vertical axis in FIG. 5 shows the values of the electrostatic capacity when the address-related electrostatic capacity a rising when the column electrodes D1 are formed directly on the back glass substrate 14 having a dielectric constant of 7.9 (i.e. when the thickness of the low-dielectric layer 15 is 0 μm) is specified as 1.

It is seen from FIG. 5 that because the low-dielectric layer 15 is formed on the back glass substrate 14, even if the low-dielectric layer 15 is thin, the address-related electrostatic capacity is decreased, and further, the thicker the low-dielectric layer 15 becomes, the greater the reduction in the address-related electrostatic capacity.

FIG. 5 describes a reduction of about 19% in the address-related electrostatic capacity when the thickness of the low-dielectric layer 15 is 100 μm as compared with the case when the low-dielectric layer 15 is not formed (i.e. the thickness of the low-dielectric layer 15 is 0 μm). However, when the thickness of the low-dielectric layer 15 is 500 μm, the reduction in the address-related electrostatic capacity is about 22%. For this reason, it is desirable that the thickness of the low-dielectric layer 15 is set at 100 μm or more. Further, when the ratio of the reduction in the address-related electrostatic capacity to the thickness of the low-dielectric layer 15 is taken into account, the thickness of the low dielectric layer 15 is desirably set at around 100 μm.

FIG. 6 is a graph showing the comparison between the address-related electrostatic capacity and the electrostatic capacity a rising between the row electrodes when voltage is applied to the row electrode pair (sustaining-related electrostatic capacity) in a conventional PDP having no low-dielectric layer 15 formed, and the address-related electrostatic capacity and the sustaining-related electrostatic capacity in the PDP of the foregoing structure including the low-dielectric layer 15.

In FIG. 6, the back glass substrate in either case has a dielectric constant of 7.9, and the low-dielectric layer 15 is formed of a low dielectric material with a dielectric constant of five to a thickness of 100 μm.

As in the case of FIG. 5, the vertical axis in FIG. 6 shows the values of the electrostatic capacity when the address-related electrostatic capacity arising when the column electrodes are formed directly on the back glass substrate having a dielectric constant of 7.9 is specified as 1.

It is seem from FIG. 6 that by forming the low-dielectric layer 15 on the back glass substrate 14, the sustaining-related electrostatic capacity, as well as the address-related electrostatic capacity, is decreased as compared with the case in the conventional PDP.

This decrease in the sustaining-system electrostatic capacity, as well as in the address-related electrostatic capacity, may be thought of as resulting from a decrease in the electrostatic capacity of the entire panel because of the provision of the low-dielectric layer 15.

In consequence, the provision of the low-dielectric layer 15 enables a reduction in the electric power required for the sustaining discharge (sustaining electric-power).

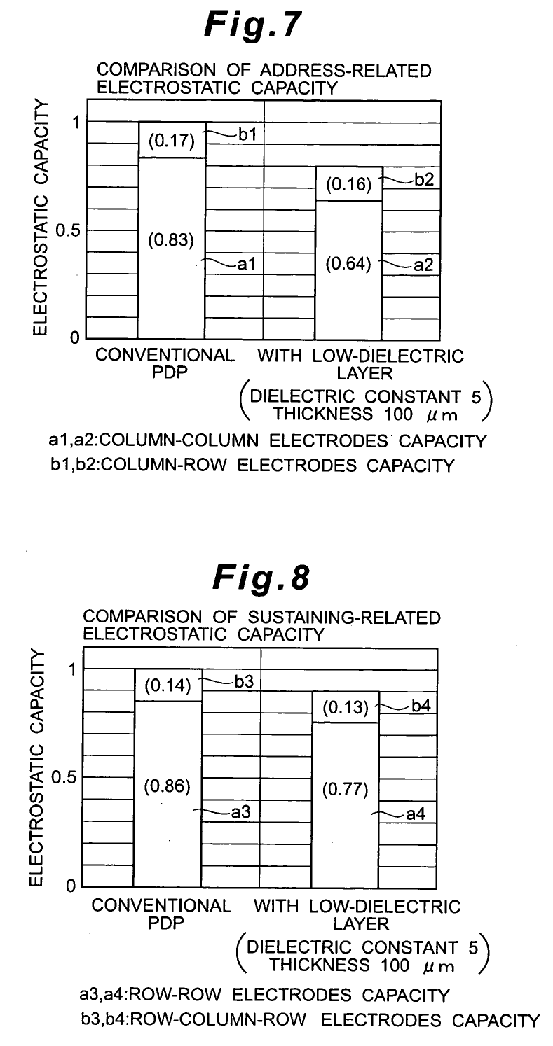

FIG. 7 is a graph showing the comparison between the address-related electrostatic capacity in a conventional PDP having no low-dielectric layer 15 formed and the address-related electrostatic capacity in the PDP of the foregoing structure including the low-dielectric layer 15.

In FIG. 7, the back glass substrate in either case has a dielectric constant of 7.9, and the low-dielectric layer 15 is formed of a low dielectric material with a dielectric constant of five to a thickness of 100 μm.

The vertical axis in FIG. 7 shows the values when the address-related electrostatic capacity in the conventional PDP having no low-dielectric layer 15 not formed is specified as 1.

Of the address-related capacity, portions a1 and a2 in the graph show the electrostatic capacities generated between the column electrode-the column electrode, and portions b1 and b2 show the electrostatic capacities generated between the column electrode-the row electrode.

It is seen from FIG. 7 that the provision of the low-dielectric layer 15 causes a decrease in the entire amount of address-related electrostatic capacity as compared with the case of the conventional PDP. Further, the decrease in the electrostatic capacity between the column electrode—the column electrode is greater than the decrease in the electrostatic capacity between column electrode—the row electrode, and the ratio of the total address-related electrostatic capacity to the electrostatic capacity between the column electrode the row electrode is higher than that in the conventional PDP.

In consequence, by providing the low-dielectric layer 15, an electric flux line is easily generated between the column electrode—the row electrode when the address discharge is produced. Thus, many portions of the electric field point toward the row electrode Y1 rather than the adjacent column electrode D1, which then makes achievement of a further stable address discharge possible.

FIG. 8 is a graph showing the comparison between the sustaining-related electrostatic capacity in a conventional PDP having no low-dielectric layer 15 formed and the sustaining-related electrostatic capacity in the PDP of the foregoing structure including the low-dielectric layer 15.

In FIG. 8, the back glass substrate in either case has a dielectric constant of 7.9, and the low-dielectric layer 15 is formed of a low dielectric material with a dielectric constant of five to a thickness of 100 μm.

The vertical axis in FIG. 8 shows the values when the sustaining-related electrostatic capacity in the conventional PDP having no low-dielectric layer 15 not formed is specified as 1.

Of the sustaining-related capacity, portions a3 and a4 in the graph show the electrostatic capacities generated between the row electrode—the row electrode, and portions b3 and b4 show the electrostatic capacities generated between the row electrode—the column electrode—the row electrode.

It is seen from FIG. 8 that the provision of the low-dielectric layer 15 causes a decrease in the entire amount of sustaining-related electrostatic capacity as compared with the case of the conventional PDP. Further, the decrease in the electrostatic capacity between the row electrode—the row electrode is greater than the decrease in the electrostatic capacity between the row electrode—the column electrode—the row electrode, and the ratio of the total sustaining-related electrostatic capacity to the electrostatic capacity between the row electrode—the column electrode—the row electrode is higher than that in the conventional PDP.

In consequence, by providing the low-dielectric layer 15, an electric flux line is easily generated between the row electrode—the column electrode—the row electrode when the sustaining discharge is produced. Therefore, many portions of the electric field point toward the back glass substrate 14. As a result, the site where the sustaining discharge is mainly produced is changed from near the front glass substrate 10 toward near the back glass substrate 14, namely, the phosphor layer 18, thereby improving the luminous efficiency as compared with the case of the conventional PDP.

The first embodiment has described the case of the low-dielectric layer 15 having the dielectric constant of five. However, if the dielectric constant of the low-dielectric layer 15 is smaller than that of the back glass substrate 14 conventionally used, for example, than 7.9, the same effects and advantages as those described hitherto can be exerted.

### Second Embodiment

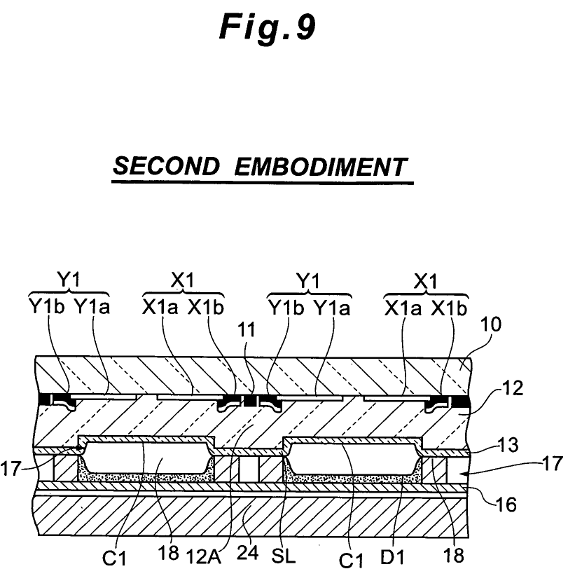

FIG. 9 is a sectional view of a PDP of a second embodiment according to the present invention, which is taken along the column direction as in the case of FIG. 3.

The PDP in the first embodiment has the low-dielectric layer 15 provided on the back glass substrate 14 and formed of the low-dielectric material having a smaller dielectric constant than that of the back glass substrate 14. The PDP in the second embodiment has a back substrate 24 constituting a low-dielectric substrate which is formed of a low-dielectric material including SiO₂ as the main ingredient as in the case of the low-dielectric layer 15 of the first embodiment, and having a dielectric constant (e.g. a dielectric constant of 5) smaller than that of a glass material of the front glass substrate 10.

A low-dielectric layer corresponding to the low dielectric layer 15 of the first embodiment is not formed on the back substrate 24. The column electrodes D1 are formed directly on the back substrate 24.

The structure of the other components is approximately the same as the structure in the PDP of the first embodiment, and the same parts of the structure are designated by the same reference numerals as those in the first embodiment.

As in the case of the PDP of the first embodiment, in the PDP of the second embodiment, the column electrodes D1 are formed on the back substrate 24 formed of the low-dielectric-constant material having a dielectric constant smaller than that of the front glass substrate 10 (namely, a conventional back glass substrate). For this reason, when a data pulse (voltage) is applied to any column electrode D1 in the address period for generating the image, the electrostatic capacity arising between the column electrode D1 to which the voltage is applied and another column electrode D1, the row electrode X1 and/or Y1 which are located close to this column electrode D1 is smaller than that in the conventional PDP. As a result, the reactive power arising when an image is generated is decreased and thus the electrical power consumption of the PDP is decreased.

This decrease in reactive power makes it possible to use a driver having a small current carrying capacity as the address driver for driving the PDP (the driver which controls the voltage applied to the column electrodes D1), leading to a reduction in manufacturing costs for the PDP.

The terms and description used herein are set forth by way of illustration only and are not meant as limitations. Those skilled in the art will recognize that numerous variations are possible within the spirit and scope of the invention as defined in the following claims.

1. A plasma display panel having row electrode pairs and column electrodes that are placed between a pair of first and second substrates facing each other on either side of a discharge space and extend in directions at right angles to each other to form unit light-emitting areas at intersections with each other in the discharge space, comprising:
a low-dielectric layer formed of a low-dielectric material having a dielectric constant smaller than that of the first substrate and provided on the first substrate, the column electrodes being formed on the low-dielectric layer.

2. A plasma display panel according to claim 1, wherein the low-dielectric layer has a thickness of over 100 μm.

3. A plasma display panel according to claim 1, wherein the low-dielectric layer has a thickness of about 100 μm

4. A plasma display panel according to claim 1, wherein the low-dielectric layer has a dielectric constant of about 5.

5. A plasma display panel according to claim 1, wherein the first substrate is a back substrate placed on a back of the panel.

6. A plasma display panel according to claim 5, wherein the low-dielectric layer formed on the back substrate has a property of reflecting visible light.

7. A plasma display panel according to claim 6, wherein a color of the low-dielectric layer is white.

8. A plasma display panel according to claim 6, wherein the low-dielectric material essentially constituting the low-dielectric layer includes a bright-colored pigment.

9. A plasma display panel according to claim 1, wherein the low-dielectric layer is formed of a low-dielectric material including SiO₂.

10. A plasma display panel comprising:
a pair of first and second substrates facing each other on either side of a discharge space, the first substrate being formed of a low-dielectric material having a dielectric constant smaller than that of the second substrate; and
row electrode pairs and column electrodes that are placed between the pair of first and second substrates and extend in directions at right angles to each other to form unit light-emitting areas at intersections with each other in the discharge space, the column electrodes being formed on the first substrate.

11. A plasma display panel according to claim 10, wherein the first substrate is a back substrate placed on a back of the panel.

12. A plasma display panel according to claim 10, wherein the first substrate has a dielectric constant of 7.9 or less.

13. A plasma display panel according to claim 10, wherein the first substrate has a dielectric constant of about 5.

14. A plasma display panel according to claim 10, wherein the first substrate has a property of reflecting visible light.

15. A plasma display panel according to claim 14, wherein a color of the first substrate is white.

16. A plasma display panel according to claim 10, wherein the first substrate is formed of a low-dielectric material including SiO₂.
